(19) United States
(12) Patent Application Publication
(10) Pub. No.: US 2014/0319941 A1
(43) Pub. Date: Oct. 30, 2014

(54) PRINTED CIRCUIT INTENDED TO ENSURE CONNECTION OF AN ELECTRIC MOTOR AND ELECTRIC MOTOR COMPRISING THE PRINTED CIRCUIT

(71) Applicant: Vincent Clerc, Clamart (FR)

(72) Inventor: Vincent Clerc, Clamart (FR)

(73) Assignee: ALDEBARAN ROBOTICS, Paris (FR)

(21) Appl. No.: 14/115,337

(22) PCT Filed: May 2, 2012
(86) PCT No.: PCT/EP2012/058039

§ 371 Date: Dec. 27, 2013

(30) Foreign Application Priority Data
May 3, 2011 (FR) 1153764

(51) Int. Cl. H02K 11/00; H02K 11/02

(52) U.S. Cl. CPC H02K 11/0005; H02K 11/024
USPC 310/71

(57) ABSTRACT

An electric motor and a printed circuit to ensure the electrical connection of the motor are provided. The printed circuit comprises: a central part to cover a first face of the electric motor; flexible tongues extending from the central part and to partly cover a second face of the motor and to be electrically connected with this second face; a first pair of studs to receive connections from the motor; a second pair of studs to receive power supply wires from the motor; tracks each connecting a stud of the first pair with a stud of the second pair; a filtering capacitor connected between the tracks; a ground plane covering most of the central part and the flexible tongues, the ground plane being electrically connected to a metal part forming the second face of the motor.

The invention relates to an electric motor and a printed circuit intended to ensure the electrical connection of the motor.

The invention is particularly suited to electric motors with brushes powered by direct current, but can equally be implemented for any type of electric motor.

Direct current motors are a source of electromagnetic noise. Electromagnetic interferences, well known in the literature as EMI, standing for “ElectroMagnetic Interference”, can be emitted by the terminals and the power supply wires of the motor. These interferences can disturb other electrical equipment located in proximity to the motor. The interferences disturb both analog equipment and digital equipment.

The greatest source of electromagnetic interference is the commutation of the motor brushes. On each commutation, when the brush breaks its contact with a segment of the commutator, the energy stored in the motor winding in electromagnetic field form provokes a voltage spike between the brush and the commutator segment. This occurs not only during normal commutation, but also in situations where the brushes bounce on the rotating commutator. It is possible to use motors without a field frame on the armature, which generate less disturbance because of the lower inductance of the armature but without completely eliminating the disturbances.

Another source of disturbance is due to the motor power supply wires. The disturbances can be conducted or radiated. Radiated disturbances can be limited by positioning the power supply terminals as close as possible to the motor itself and using twisted wires to power the motor via its terminals. Unfortunately, some manufacturers of inexpensive electric motors offer remote terminals which can even be diametrically opposite. In this case, even by using a pair of twisted wires, a current loop remains at the terminals, such loops having a tendency to radiate electromagnetic energy.

Conductive disturbances can be limited by placing filtering components in the vicinity of the motor. It is common practice to position inductors in series on the motor power supply wires and capacitors connected between the power supply wires and a ground of the equipment to which the motor belongs. Each of the capacitors can be soldered between one of the terminals of the motor and the metal field frame of the stator.

These filtering components present drawbacks. They are first of all bulky and therefore increase the footprint of the equipment. If the equipment is subject to vibration, the filtering components can be subject to different displacements from those of the motor and thus create stresses at their electrical connections which can even result in the connections being broken. The weight of the filtering components is also a drawback notably in embedded applications such as, for example, in humanoid robotics. In practice, the weight increase means that the torque exerted by the motors in the movements of the robot has to be increased, leading to greater electrical consumption and therefore reduced autonomy of the robot.

Also, the filtering produced is far from being uniform frequency-wise. Furthermore, the capacitors and inductors are discrete elements added in pairs to each of the power supply wires. In one pair, the values of each component can differ within their manufacturing tolerance range. These differences reduce the filtering quality, notably for differential mode disturbances. Another drawback lies in the soldering of the capacitors onto the field frame of the motor. In an electric motor with brushes powered by direct current, the stator field frame houses permanent magnets. These magnets can be affected by the soldering which can locally raise the temperature of the magnet beyond its Curie point.

The control of the motors is also a source of electromagnetic disturbances. This control can be done by high-frequency switching of the direct current. This type of switching is well known in the literature by the acronym PWM, standing for “Pulse Width Modulation”. Electronic switches chop the direct current with steep edges generating numerous harmonics which are both conducted and radiated by the motor power supply wires. This type of disturbance can be attenuated by means of the filtering components and also by means of shieldings in which the motor can be placed. The use of twisted pairs is also beneficial in limiting this type of disturbance. The shieldings generally consist of added metal parts and therefore tend to increase the weight, the volume and the cost of the motor environment.

The invention aims to limit the disturbances emitted and radiated by an electric motor by proposing a solution that is simple to implement, lightweight, which can be used for inexpensive motors and which can easily be adapted to motors from different suppliers even when the dimensions and the positions of the connection terminals differ. The invention also makes it possible to limit the susceptibility of the motor to disturbances originating from its environment.

To this end, the subject of the invention is a printed circuit intended to be fixed to an electric motor to ensure its electrical connection, characterized in that it comprises:
a central part intended to cover a first face of the electric motor,
flexible tongues extending from the central part and intended to partly cover a second face of the motor and to be electrically connected with this second face,
a first pair of studs intended to receive connections from the motor,
a second pair of studs intended to receive power supply wires from the motor,
tracks each connecting a stud of the first pair with a stud of the second pair,
a filtering capacitor connected between the tracks,
a ground plane covering most of the central part and the flexible tongues, the ground plane being intended to be electrically connected to a metal part forming the second face of the motor.

Another subject of the invention is an electric motor comprising a printed circuit according to the invention.

The invention will be better understood and other advantages will become apparent on reading the detailed description of an embodiment given as an example, the description being illustrated by the attached drawing in which:

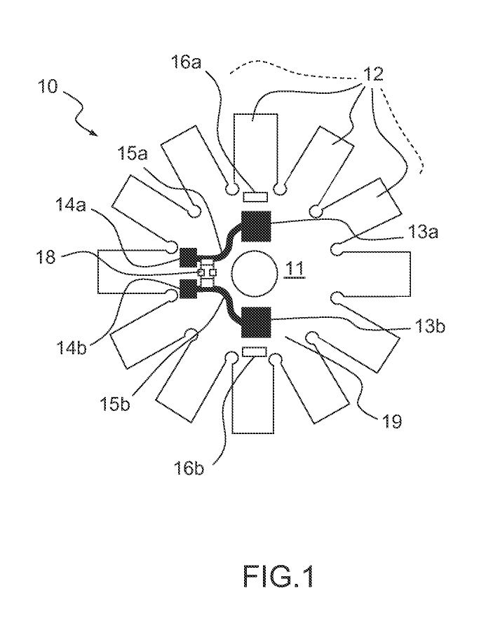

FIG. 1 represents a printed circuit conforming to the invention;

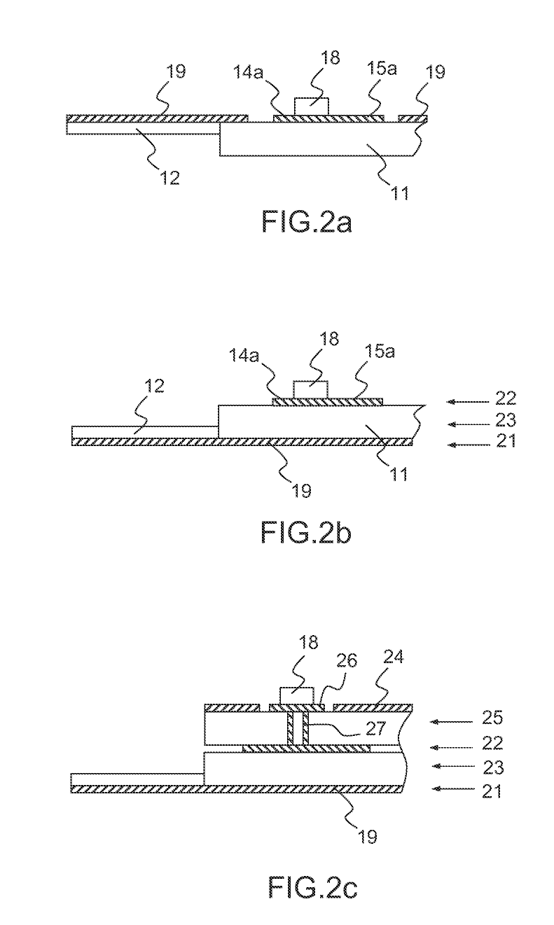

FIGS. 2a, 2b and 2c schematically represent, in cross section, examples of the stacking of layers forming the printed circuit;

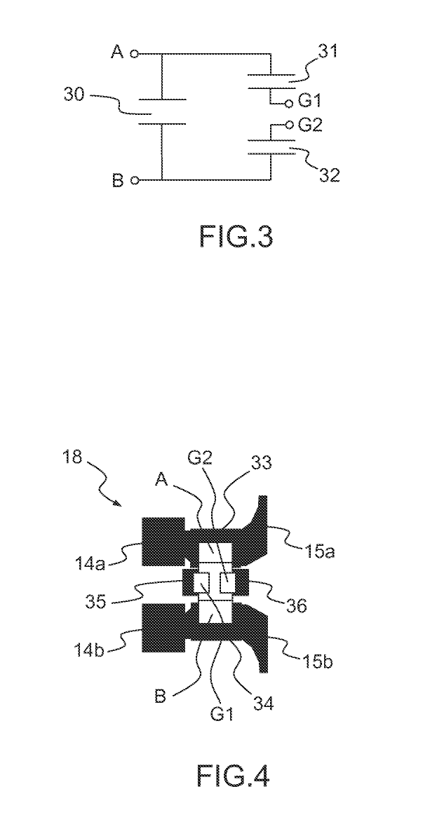

FIG. 3 schematically represents a filtering capacitor with which the printed circuit can be equipped;

FIGS. 4, 5 and 6 represent variants of filtering capacitors with which the printed circuit can be equipped;

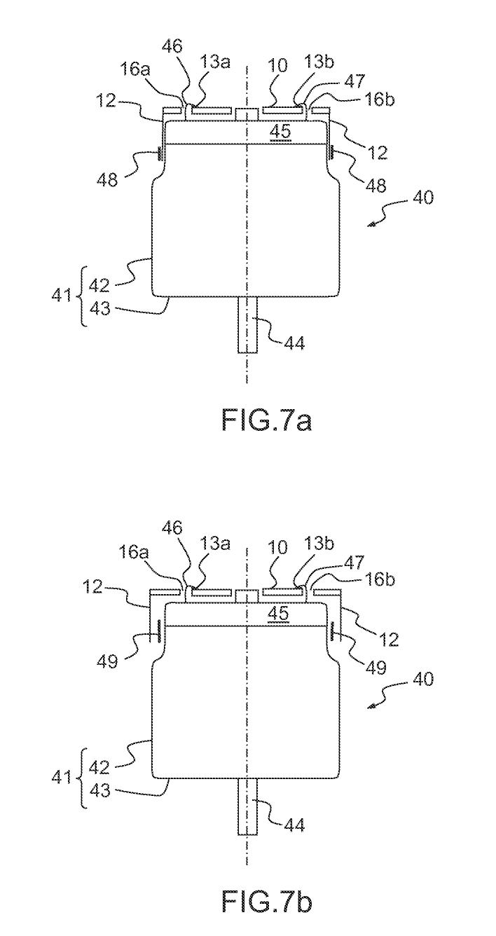

FIGS. 7a and 7b represent the printed circuit mounted on an electric motor.

For clarity, the same elements will be given the same references in the different figures.

Most rotating electric motors overall have an outer surface in the form of a cylinder portion limited by two planar surfaces. The axis of rotation of the motor is the axis of the cylinder and the motor connections are made on one of the two planar surfaces by tongues to which power supply wires can be connected, for example by soldering or via a connector. Hereinafter, the term “motor power supply wires” will include any connection means for the motor to ensure its power supply, such as, for example, a flexible printed circuit. The cylindrical portion and one of the two planar surfaces can be formed by a metal jacket. The second planar surface can be made of plastic material through which the motor connections leave.

FIG. 1 represents a single-sided printed circuit 10 intended to be fixed to an electric motor to ensure its electrical connection. It will be recalled that a single-sided printed circuit is formed by an insulating substrate with one of its faces receiving conductive tracks. The implementation of a single-sided printed circuit then makes it possible to reduce its production cost. The printed circuit 10 comprises a central part 11 intended to cover the planar surface through which the motor connections leave. In the example represented, the central part 11 is circular in order to be adapted to the most common motors. The diameter of the central part 11 is substantially equal to that of the planar surface of the motor that the central part 11 has to cover. Obviously, other forms are possible.

The printed circuit 10 also comprises flexible tongues 12 extending the central part and intended to partly cover the cylindrical surface of the motor. The flexibility of the tongues makes it possible to fold them back along the cylindrical surface. In FIG. 1, the printed circuit 10 is shown flat before the tongues 12 are folded back. In the case of a circular central part 11, the tongues 12 extend around the central part 11 according to radii of the central part 11 when the printed circuit 10 is flat. In FIG. 1, twelve tongues 12 are uniformly distributed around the central part 11. Obviously, the invention is not limited to this number of tongues.

The printed circuit 10 also comprises a first pair of studs 13a and 13b intended to receive connections from the motor and the second pair of studs 14a and 14b intended to receive motor supply wires. A track 15a connects the studs 13a and 14a. A track 15b connects the studs 13b and 14b.

Two holes 16a and 16b can be provided, passing through the printed circuit 10 and intended to allow for the passage of the motor connection terminals. The hole 16a is produced in the vicinity of the stud 13a and the hole 16b is produced in the vicinity of the stud 13b.

A filtering capacitor 18 is connected between the tracks 15a and 15b. A ground plane 19 covers most of the central part 11 and the flexible tongues 12. In the case of a single-sided printed circuit, as represented in cross section in FIG. 2a, the ground plane 19 is cut out to leave space for the studs 13a, 13b, 14a, 14b and for the tracks 15a and 15b.

It is also possible to produce a double-sided printed circuit as represented in cross section in FIG. 2b. The ground plane 19 is produced on an outer face of the printed circuit 10 and the studs and the tracks are produced on the opposite outer face. In other words, the printed circuit 10 comprises two conductive layers 21 and 22 separated by an insulating layer 23. The layer 21 forms the ground plane 19. The tracks 15a and 15b and the two pairs of studs 13a, 13b, 14a, 14b are etched in the layer 22. When the printed circuit 10 is mounted on an electric motor, the ground plane 19 is intended to face the surface of the electric motor covered by the printed circuit 10. Thus, the ground plane 19 serves as a screen between the motor and the tracks 15a and 15b in order to better protect them from disturbances radiated by the motor.

The protection of the tracks 15a and 15b can be further improved by adding a second ground plane 24, as represented in cross section in FIG. 2c. The tracks 15a and 15b are then bracketed between the two ground planes 19 and 24. In other words, the printed circuit 10 comprises a third conductive layer forming the second ground plane 24, an insulating layer 25 being arranged between the conductive layers 22 and 24. The ground plane 24 is cut out to leave space for contact lands 26 for receiving the capacitor 18. The contact lands 26 are connected to the tracks 15a and 15b by means of plated through-holes 27.

Advantageously, the capacitor 18 is of X2Y type and is connected to the tracks 15a and 15b and to the ground plane 19. This type of capacitor is manufactured by the company Johanson Dielectrics located at 15191 Bledsoe St. Sylmar, Calif., in the United States. Complete documentation for this type of capacitor can be consulted on the website www.x2y.com.

FIG. 3 shows an equivalent circuit diagram of a capacitor of X2Y type. This component comprises four connection terminals A, B, G1 and G2. A main individual capacitor 30 is connected between the terminals A and B and two auxiliary individual capacitors 31 and 32 are connected between the terminal A and the terminal G1 for the capacitor 31 and between the terminal B and the terminal G2 for the capacitor 32. For its production, the electrodes of the different capacitors 30, 31 and 32 are interleaved and the assembly is encapsulated in a package intended to be surface mounted on a printed circuit without through-holes. The two auxiliary capacitors 31 and 32 are perfectly matched.

FIG. 4 represents the capacitor 18 of X2Y type mounted on the printed circuit 10 in such a way that the terminals A and B are each connected to one of the tracks 15a and 15b and the terminals G1 and G2 are connected to the ground plane 19. The use of the three individual capacitors 30, 31 and 32 makes it possible to limit both the common mode disturbances and the differential disturbances. The nesting of the different individual capacitors 30, 31 and 32 makes it possible to compensate the radiation emitted by each of the tracks 15a and 15b. The capacitor 18 of X2Y type is, for example, produced in a package intended to be surface mounted on the printed circuit 10. To this end, the track 15a comprises a connection land 33 to accommodate the terminal A, the track 15b comprises a connection land 34 to accommodate the terminal B and the ground plane 19 comprises two connection lands 35 and 36 to accommodate the terminals G1 and G2. The different terminals of the capacitor 18 are soldered onto their respective connection lands.

Alternatively, the filtering capacitor is formed by two capacitors 37 and 38 connected in series between the tracks 15a, 15b. The ground plane 19 is then connected to the common terminals of the two capacitors 37 and 38. The two capacitors 37 and 38 are discrete and of the same value. In order to give a good understanding of the electrical similarity with FIG. 4, the terminal names A and G1 have been retained for the capacitor 37 and the terminal names B and G2 have been retained for the capacitor 38. It is then desirable to position the two discrete capacitors 37 and 38 as close to one another as possible as represented in FIG. 5, so as to generate a mutual inductance that is as great as possible between the two discrete capacitors 37 and 38. More specifically, the terminals A and G2 on the one hand and the terminals B and G1 on the other hand are positioned as close as possible. This arrangement makes it possible to reduce the emitted radiation and the susceptibility to external radiation of the two tracks 15a and 15b. As in the alternative implementing a capacitor of X2Y type, the capacitors 37 and 38 can be produced in a package intended to be surface-mounted on the printed circuit 10. To this end, FIG. 4 also shows the connection lands 33 to 36. This alternative, however, provides less good electromagnetic disturbance filtering results than with a capacitor of X2Y type. With the two discrete capacitors, only the common mode disturbances of the two tracks 15a and 15b relative to the ground are filtered.

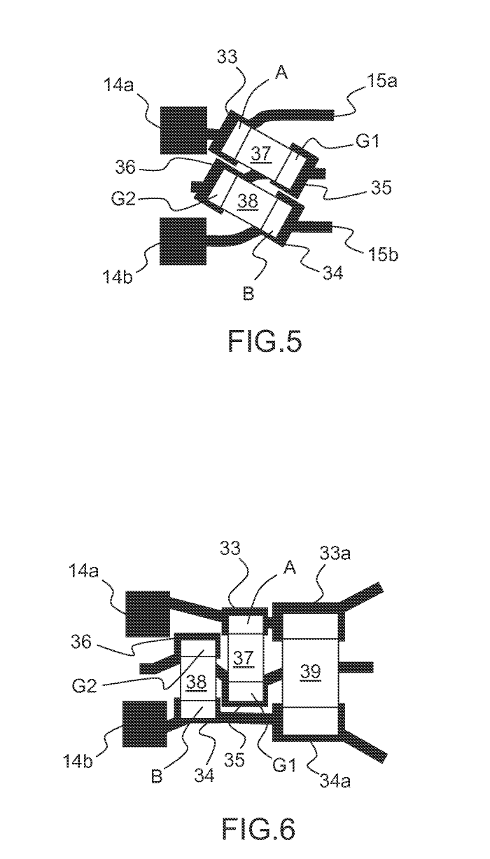

By using discrete capacitors, it is possible to further improve the filtering by adding a third capacitor 39 connected between the tracks 15a and 15b, as represented in FIG. 6. The capacitor 39 is electrically equivalent to the individual capacitor 30 of the capacitor of X2Y type. The capacitor 39 makes it possible to filter the differential mode disturbances between the two tracks 15a and 15b. The capacitor 39 can be produced in a package intended to be surface mounted on the printed circuit 10. To this end, the capacitor 39 is soldered between a connection land 33a belonging to the track 15a and a connection land 33b belonging to the track 15b. As previously, it is advantageous to position the three discrete capacitors 37, 38 and 39 as close to one another as possible as represented in FIG. 6, so as to generate a mutual inductance that is as great as possible between them.

Despite the above, the performance of the capacitor of X2Y type whose electrodes are interleaved, which makes it possible to maximize the mutual inductance of the different individual capacitors 30, 31 and 32 of which it is composed, is not achieved. Furthermore, the individual capacitors 31 and 32 are better matched than when discrete capacitors 37 and 38 are implemented. In other words, a capacitor of X2Y type better filters the common mode disturbances than the two discrete capacitors 37 and 38.

FIGS. 7a and 7b represent an electric motor 40 equipped with the printed circuit 10. The motor 40 comprises a metal jacket 41 in the form of a cylindrical surface 42 and a planar bottom 43. An output shaft 44 of the motor extends along the axis of the cylindrical surface 42 and exits from the motor 40 through the bottom 43. The motor 40 is enclosed by a plastic cover 45 forming a circular planar surface parallel to the bottom 43. Two terminals 46 and 47 exit from the cover 45 and form the power supply terminals of the motor 40. The printed circuit 10 is arranged against the cover 45. More specifically, the central part 11 is placed parallel to the planar surface formed by the cover 45. Each of the terminals 46 and 47 passes through one of the holes 16a and 16b of the printed circuit 10 and then is folded back parallel to the central part 11 to be connected to each of the respective studs 13a and 13b, for example by soldering.

The tongues 12 are folded back along the cylindrical surface 42 at right angles to the plane of the central part 11 so that the ground plane 19 can come into electrical contact with the metal jacket 41 on the cylindrical surface 42. An electrical connection of the terminals G1 and G2 of the capacitor 18 to the metal jacket 41 is thus obtained.

The use of the flexible tongues 12 makes it possible to place the printed circuit 10 on motors for which the diameter of the cylindrical surface can vary slightly. It will be possible, for example, in series production, to implement electric motors originating from different manufacturers.

Furthermore, again assuming different manufacturers, it is possible to provide a plurality of pairs of holes 16a and 16b, if the different manufacturers retained offer terminals located at different points on the cover 45.

The electrical connection of the ground plane 19 on the tongues 12 and of the metal jacket 41 on the cylindrical surface 42 can be made by direct contact as represented in FIG. 7a. The tongues 12 can be kept pressed against the metal jacket 41 by means of an adhesive tape 48 around the tongues 12. Alternatively, as represented in FIG. 7b, it is possible to ensure this connection by interposing a double-sided conductive adhesive 49 adhering on the one hand to the cylindrical surface 42 and on the other hand to the tongues 12.

1. A printed circuit intended to be fixed to an electric motor to ensure its electrical connection, comprising:
a central part intended to cover a first face of the electric motor (40),
flexible tongues extending from the central part and intended to partly cover a second face of the motor and to be electrically connected with this second face,
a first pair of studs intended to receive connections from the motor,
a second pair of studs intended to receive power supply wires from the motor,
tracks each connecting a stud of the first pair with a stud of the second pair,
a filtering capacitor connected between the tracks, and
a ground plane covering most of the central part and the flexible tongues, the ground plane being intended to be electrically connected to a metal part forming the second face of the motor.

2. The printed circuit as claimed in claim 1, wherein the capacitor is of X2Y type and is connected to the tracks and to the ground plane.

3. The printed circuit as claimed in claim 1, wherein the filtering capacitor is formed by two discrete capacitors connected in series between the tracks and the ground plane is connected to common terminals of the two capacitors.

4. The printed circuit as claimed in claim 3, further comprising a third discrete capacitor connected between the tracks.

5. The printed circuit as claimed in claim 1, wherein the discrete capacitors are arranged as close as possible to one another so as to generate a mutual inductance that is as great as possible between them.

6. The printed circuit as claimed in claim 1, wherein the central part is circular and in that the tongues extend around the central part (11) according to radii from the central part when the printed circuit is flat.

7. The printed circuit as claimed in claim 1, wherein it is single-sided.

8. The printed circuit as claimed in claim 1, further comprising two conductive layers separated by an insulating layer, in that wherein a first of the two conductive layers forms the ground plane (19), the tracks and the two pairs of studs are etched in the second of the two conductive layers and the ground plane is intended to face the first face of the electric motor.

9. The printed circuit as claimed in claim 8, wherein the second conductive layer is arranged between the first conductive layer and a third conductive layer forming a second ground plane, a second insulating layer being arranged between the second and the third conductive layers.

10. An electric motor, further comprising a printed circuit as claimed in claim 1.

11. The electric motor as claimed in claim 10, wherein the electrical connection of the ground plane on the tongues and the second face of the motor is made by direct contact and the tongues are kept pressed against the second face by means of an adhesive tape surrounding the tongues.

12. The electric motor as claimed in claim 11, wherein the electrical connection of the ground plane on the tongues and on the second face of the motor is ensured by interposing a double-sided conductive adhesive adhering on the one hand to the second face and on the other hand to the tongues.

13. The printed circuit as claimed in claim 4, wherein the discrete capacitors are arranged as close as possible to one another so as to generate a mutual inductance that is as great as possible between them.
